(19) United States
(12) Patent Application Publication
(10) Pub. No.: US 2016/0009869 A1
(43) Pub. Date: Jan. 14, 2016

(54) PREPARATION OF POLYAMIDES BY HYDROLYTIC POLYMERIZATION, POSTPOLYMERIZATION AND SUBSEQUENT EXTRACTION

(71) Applicant: BASF SE, Ludwigshafen (DE)

(72) Inventors: Silke BIEDASEK, Mannheim (DE); Achim STAMMER, Freinsheim (DE); Gad KORY, Gaiberg (DE); William E. GRANT, Angelton, TX (US)

(73) Assignee: BASF SE, Ludwigshafen (DE)

(21) Appl. No.: 14/771,578

(22) PCT Filed: Mar. 6, 2014
(86) PCT No.: PCT/EP14/54324

§ 371 Date: Aug. 31, 2015

Related U.S. Application Data
(60) Provisional application No. 61/773,846, filed on Mar. 7, 2013.

(51) Int. Cl. C08J 3/00; D01F 6/60; C08G 69/16; C08J 5/18

(52) U.S. Cl. CPC C08J 3/00; C08J 5/18; D01F 6/60; C08G 69/16; C08J 2377/02

(57) ABSTRACT

The present invention relates to a process for preparing polyamides, comprising a hydrolytic polymerization, a postpolymerization and an extraction.

### BACKGROUND OF THE INVENTION

The present invention relates to a process for preparing polyamides, comprising a hydrolytic polymerization, a postpolymerization and an extraction.

### STATE OF THE ART

Polyamides are one of the polymers produced on a large scale globally and, in addition to the main fields of use in fibers, materials and films, serve for a multitude of further end uses. Among the polyamides, polyamide-6 (polycaprolactam) with a proportion of about 57% is the most commonly produced polymer. The conventional process for preparing polyamide-6 is the hydrolytic polymerization of ε-caprolactam, which is still of very great industrial significance. Conventional hydrolytic preparation processes are described, for example, in Ullmann's Encyclopedia of Industrial Chemistry, Online Edition Mar. 15, 2003, vol. 28, p. 552-553 and Kunststoffhandbuch, 3/4 Technische Thermoplaste: Polyamide [Plastics Handbook, 3/4 Industrial Thermoplastics: Polyamides], Carl Hanser Verlag, 1998, Munich, p. 42-47 and 65-70.

In the first step of the hydrolytic polymerization, a portion of the lactam used reacts through the action of water with ring opening to give the corresponding ω-aminocarboxylic acid. The latter then reacts with further lactam in polyaddition and polycondensation reactions to give the corresponding polyamide. In a preferred variant, ε-caprolactam reacts through the action of water with ring opening to give aminocaproic acid and then further to give polyamide-6. The hydrolytic polymerization can be effected in one or more stages. In general, the polycondensation and polyaddition are effected in a vertical tubular reactor (VK tube). This German abbreviation “VK” stands for “vereinfacht kontinuierlich” [“simplified continuous”]. Optionally, it is possible to use a plant with a prepolymerization stage at elevated pressure. The use of such a preliminary reactor reduces the residence time required for the ring-opening reaction of the ε-caprolactam. At the end of the vertical tubular reactor (VK tube), a polyamide melt having a composition close to the chemical equilibrium and composed of polyamide, lactam monomer, oligomers and water is obtained. The content of oligomers and monomers may, for example, be 8 to 15% by weight and the viscosity number of the crude polyamide, which is directly related to the molar mass and hence the processing properties, is generally between 110 and 160 ml/g.

Many end uses, for example for production of films for packaging materials, require a relatively low residual monomer content in the polyamide, and so the crude polyamide, prior to the further processing thereof, is generally subjected to an at least partial removal of monomers and/or oligomers.

To reduce the content of low molecular weight components, pellets of crude polyamide particles are generally first obtained from the product of the hydrolytic polymerization and these are then extracted with an extractant, in order to remove remaining monomers and oligomers. This is frequently effected by continuous or batchwise extraction with hot water, as described, for example; in DE 25 01 348 A and DE 27 32 328 A. For purification of crude polyamide-6, extraction with caprolactam-containing water (WO 99/26996 A2) or treatment in a superheated water vapor stream (EP 0 284 986 A1) is also known. For reasons of environmental protection and of economic viability, the extracted constituents, more particularly the caprolactam and the cyclic oligomers in the case of polyamide-6, are recycled into the process. The extraction is typically followed by drying of the extracted polyamide.

Many applications additionally require polyamides having relatively high molecular weights which are not achieved by the hydrolytic polymerization alone. To increase the molecular weight or the viscosity of the polyamide, a postcondensation can be performed after the extraction and drying, the polyamide preferably being in the solid phase (solid phase condensation). For this purpose, the pellets can be heat treated at temperatures below the melting point of the polyamide, in the course of which there is continuation of the polycondensation in particular. This leads to an increase in the molecular weight and hence to an increase in the viscosity number of the polyamide. In general, the viscosity number of polyamide-6 after the extraction and postpolymerization is about 180 to 260 ml/g.

Postcondensation and drying are frequently performed in one step, as described in WO 2009/153340 A1 and DE 199 57 664 A1.

DD 2090899 describes a process for removing low molecular weight constituents from a polyamide melt by subjecting it to an extraction with monomeric caprolactam and then to a removal of monomers under reduced pressure.

DD 227140 describes a process for preparing polyamide having a degree of polymerization DP>200. The process features at least 5 successive stages. At the start of each drying stage, the surface of the molten polyamide is adjusted to >4 cm²/g of polyamide and the maximum diffusion distance of the water in the melt is adjusted to <3 mm.

WO 03/040212 discloses a method for preparing polyamide-6 by hydrolytic polymerization of s-caprolactam under the action of water. The dewatering is achieved by the increase in the surface area of the melt.

WO 2009/153340 A1 describes a continuous method for multi-staged drying and subsequent condensation of solid phase polyamide granulate, characterized in that:
1) the pre-drying is carried out in a continuous drying apparatus with inert gas, steam or a mixture of inert gas and steam at a granulate temperature in the range of 70 to 200° C. and
2) the subsequent continuous post-condensation is carried out in a separate shaft with a moving bed at a granulate temperature in the range of 120 to 210° C., wherein the shaft is operated with inert gas, steam or a mixture of inert gas and steam, and the inert gas is fed at least two points along the shaft.

An alternative route, which is not utilized significantly on the industrial scale, for preparation of polyamides is the polycondensation of amino nitriles, for example the preparation of polyamide-6 from 6-aminocapronitrile (ACN). According to a customary procedure, this process comprises a nitrile hydrolysis and subsequent amine amidation, which is generally performed in separate reaction steps in the presence of a heterogeneous catalyst, such as TiO₂. A multistage mode of operation has been found to be practicable, since the two reaction steps have different requirements in terms of water content and completeness of the reaction. In the case of this synthesis route too, it is in many cases advantageous to subject the polyther obtained to a purification for removal of monomers/oligomers.

WO 00/47651 A1 describes a continuous process for preparing polyamides by reaction of at least one aminocarbonitrile with water.

The known processes for preparing polyamides by hydrolytic polymerization are still in need of improvement. For instance, the residual monomer content, specifically of ε-caprolactam, at the start of postpolymerization of the crude polyamide in the solid phase, is well below the equilibrium value. Thus, during the final postpolymerization, a reverse polyaddition (remonomerization) reaction can take place, such that the residual monomer content of the polyamide increases again in the last step of the preparation process.

It is therefore an object of the present invention to provide an improved process for preparing polyamides by hydrolytic polymerization, in which the aforementioned disadvantages are avoided. More particularly, it is to be possible by this process to provide a product having very low residual monomer content.

It has now been found that, surprisingly, this object is achieved when the reaction product which is obtained in the hydrolytic polymerization and comprises polyamide, water, unconverted monomers and oligomers is subjected to a pelletization, then the pellets are subjected to a postpolymerization in the solid phase and the product of the postpolymerization is then subjected to an extraction. While, in conventional processes, the drying of the extracted polymer particles and the postpolymerization are generally integrated into one process step, decoupling is effected in accordance with the invention into two different process steps. This has the advantage that the two steps can be performed under different process conditions, for example at different temperatures and/or with different residence times. It is thus possible, more particularly, to perform the final drying under conditions under which the remonomerization is only of minor importance. The process according to the invention can achieve polyamides with lower residual monomer content compared to conventional processes. More particularly, it is possible to provide polyamides simultaneously having a low residual content of monomeric lactam and of cyclic dimer.

### SUMMARY OF THE INVENTION

The invention therefore provides a process for preparing polyamides, in which
a) a monomer composition comprising at least one lactam or at least one aminocarbonitrile and/or oligomers of these monomers is provided,
b) the monomer composition provided in step a) is converted in a hydrolytic polymerization at elevated temperature in the presence of water to obtain a reaction product comprising polyamide, water, unconverted monomers and oligomers,
c) the reaction product obtained in step b) is subjected to shaping to obtain polyamide particles,
d) the polyamide particles obtained in step c) are fed into a reaction zone for postpolymerization,
e) the polyamide obtained in step d) is treated with at least one extractant.

More particularly, the extracted polyamide obtained in step e) of the process according to the invention is additionally subjected to drying (step f)).

More particularly, the polyamide particles obtained in step c) of the process according to the invention are fed into a reaction zone for postpolymerization without being subjected to an extraction beforehand.

The invention further provides polyamides obtainable by the process described above and hereinafter. These polyamides feature a very low residual monomer content unachievable by processes known from the prior art.

The invention further provides for the use of polyamides obtainable by the process described above and hereinafter, especially for production of pellets, films, fibers or moldings.

### DETAILED DESCRIPTION OF THE INVENTION

In the context of the present invention, “monomer” is understood to mean a low molecular weight compound as used in the preparation of the polyamide by hydrolytic polymerization for introduction of a single repeat unit. These include the lactams and aminocarbonitriles used. These also include any comonomers used for preparation of the polyamides, such as ω-aminocarboxylic acids, ω-aminocarboxamides, ω-aminocarboxylic salts, ω-aminocarboxylic esters, diamines and dicarboxylic acids, dicarboxylic acid/diamine salts, dinitriles and mixtures thereof.

In the context of the present invention, an oligomer is understood to mean a compound as formed in the preparation of the polyamides by reaction of at least two of the compounds which form the individual repeat units. These oligomers have a lower molecular weight than the polyamides prepared in accordance with the invention. The oligomers include cyclic and linear oligomers, specifically cyclic dimer, linear dimer, trimer, tetramer, pentamer, hexamer and heptamer. Standard processes for determining the oligomeric components of polyamides generally cover the components up to the heptamer.

The viscosity number (Staudinger function, referred to as VN or J) is defined as VN=1/c×(η−ηₛ)/ηₛ. The viscosity number is directly related to the mean molar mass of the polyamide and gives information about the processibility of a polymer. The viscosity number can be determined to EN ISO 307 with an Ubbelohde viscometer.

The process according to the invention has the following advantages:
The final extraction in step e) is the last process step, or the extraction step is not followed by any further process step associated with any significant thermal stress on the polymer, as occurs, for example, in the postpolymerization. Thus, the reformation of monomers and/or oligomers, as occurs at relatively high temperatures as an equilibrium reaction, is avoided. Thus, very low residual monomer contents are enabled.
The process according to the invention features a small number of process steps required to achieve the desired low residual monomer contents.

Step a)

In step a) of the process according to the invention, a monomer mixture comprising at least one lactam or at least one aminocarbonitrile and/or oligomers of these monomers and possibly further components is converted under polyamide-forming reaction conditions, forming a polyamide.

According to the invention, polyamides are understood to mean homopolyamides, copolyamides and polymers incorporating at least one lactam or nitrile and at least one further monomer and having a content of at least 60% by weight of polyamide-base units, based on the total weight of the monomer base units in the polyamide.

Homopolyamides derive from an aminocarboxylic acid or a lactam and can be described by a single repeat unit. Polyamide-6 base units can be formed, for example, from caprolactam, aminocapronitrile, aminocaproic acid or mixtures thereof. Examples of homopolyamides are nylon-6 (PA 6, polycaprolactam), nylon-7 (PA 7, polyenantholactam or polyheptanamide), nylon-10 (PA 10, polydecanamide), nylon-11 (PA 11, polyundecanolactam) and nylon-12 (PA 12, polydodecanolactam).

Copolyamides derive from several different monomers, the monomers each being joined to one another by an amide bond.

Possible copolyamide units may derive, for example, from lactams, aminocarboxylic acids, dicarboxylic acids and diamines. Preferred copolyamides are polyamides formed from caprolactam, hexamethylenediamine and adipic acid (PA 6/66). Copolyamides may comprise the polyamide units in various ratios.

Polyamide copolymers comprise, as well as the polyamide base units, further base units not joined to one another by amide bonds. The proportion of comonomers in polyamide copolymers is preferably not more than 40% by weight, more preferably not more than 20% by weight, especially not more than 10% by weight, based on the total weight of the base units of the polyamide copolymer.

The polyamides prepared by the process according to the invention are preferably selected from polyamide-6, polyamide-11, polyamide-12, and the copolyamides and polymer blends thereof. Particular preference is given to polyamide-6 and polyamide-12; polyamide-6 is especially preferred.

The monomer mixture provided in step a) preferably comprises at least one C₅- to C₁₂-lactam and/or an oligomer thereof. The lactams are especially selected from ε-caprolactam, 2-piperidone (δ-valerolactam), 2-pyrrolidone (γ-butyrolactam), capryllactam, enantholactam, lauryllactam, and the mixtures and oligomers thereof. Particular preference is given to providing, in step a), a monomer mixture comprising ε-caprolactam, 6-aminocapronitrile and/or an oligomer thereof. More particularly, in step a), a monomer mixture comprising exclusively ε-caprolactam or exclusively 6-aminocapronitrile as a monomer component is provided.

In addition, it is also possible that, in step a), a monomer mixture comprising, in addition to at least one lactam or aminocarbonitrile and/or oligomer thereof, at least one monomer (M) copolymerizable therewith is provided.

Suitable monomers (M) are dicarboxylic acids are, for example, aliphatic C₄₋₁₀-alpha,omega-dicarboxylic acids such as succinic acid, glutaric acid, adipic acid, pimelic acid, suberic acid, azelaic acid, sebacic acid and dodecanedioic acid. It is also possible to use aromatic C₈₋₂₀-dicarboxylic acids such as terephthalic acid and isophthalic acid.

As diamines suitable as monomers (M), it is possible to use α,ω-diamines having four to ten carbon atoms, such as tetramethylenediamine, pentamethylenediamine, hexamethylenediamine, heptamethylenediamine, octamethylenediamine, nonamethylenediamine and decamethylenediamine. Particular preference is given to hexamethylenediamine.

Among the salts of said dicarboxylic acids and diamines suitable as monomers (M), the salt of adipic acid and hexamethylenediamine, called AH salt, is especially preferred.

Suitable monomers (M) are also lactones. Preferred lactones are, for example, ε-caprolactone and/or γ-butyrolactone.

In the preparation of the polyamides, it is possible to use one or more chain transfer agents, for example aliphatic amines or diamines such as triacetonediamine or mono- or dicarboxylic acids such as propionic acid and acetic acid or aromatic carboxylic acids such as benzoic acid or terephthalic acid.

Step b)

The conversion of the monomer mixture provided in step a) in a hydrolytic polymerization in step b) can be effected by standard processes known to those skilled in the aft Such a process is described, for example, in Kunststoff Handbuch, 3/4 Technische Thermoplaste: Polyamide, Carl Hanser Verlag, 1998, Munich, p. 42-47 and 65-70. This disclosure is fully incorporated here by reference.

Preferably, in step b), hydrolytic polymerization is accomplished by subjecting a lactam to ring opening under the action of water. This involves, for example, at least partly cleaving the lactam to give the corresponding aminocarboxylic acid, which is then polymerized further in the subsequent step by polyaddition and polycondensation. If, in a preferred embodiment, in step a), a monomer mixture comprising caprolactam is provided, the latter is at least partly opened under the action of water to give the corresponding aminocaproic acid and then reacts with polycondensation and polyaddition to give polyamide-6. In an alternative version, in step b), an aminocarbonitrile, specifically 6-aminocapronitrile, is subjected to a polymerization under the action of water and optionally in the presence of a catalyst.

The conversion in step b) is preferably continuous.

Preferably, the hydrolytic polymerization in step b) is effected in the presence of 0.1 to 25% by weight of added water, more preferably of 0.5 to 20% by weight of added water, based on the total amount of monomers and oligomers used. Additional water formed in the condensation reaction is not included in this stated amount.

The hydrolytic polymerization in step b) can be effected in one or more stages (for example two stages). When the hydrolytic polymerization in step b) is performed in one stage, the starting concentration of water is preferably 0.1 to 4% by weight based on the total amount of monomers and oligomers used. When the hydrolytic polymerization in step b) is performed in two stages, the VK tube is preferably connected downstream of a preliminary pressure stage, for example a preliminary pressure reactor. In the preliminary pressure stage, the starting concentration of water is preferably 2 to 25% by weight, more preferably 3 to 20% by weight, based on the total amount of monomers and oligomers used.

In a specific version, the monomer mixture provided in step a) consists of at least one lactam and the hydrolytic polymerization in step b) is effected in the presence of 0.1 to 4% by weight of water; based on the total amount of the lactam used. The lactam is specifically ε-caprolactam.

The hydrolytic polymerization in step b) can be effected in the presence of at least one regulator, such as propionic acid. If a regulator is used in step b) and the hydrolytic polymerization is performed in two stages using a preliminary pressure stage, the regulator can be used in the preliminary pressure stage and/or in the second polymerization stage. In a specific version, the hydrolytic polymerization in step b) is not effected in the presence of a regulator.

The polyamides prepared in the process according to the invention may additionally comprise customary additives such as matting agents, e.g. titanium dioxide, nucleators, e.g. magnesium silicate, stabilizers, e.g. copper(I) halides and alkali metal halides, antioxidants, reinforcers, etc., in customary amounts. The additives are generally added before, during or after the hydrolytic polymerization (step b). Preference is given to adding the additives before the hydrolytic polymerization in step b).

The conversion in step b) can be effected in one or more stages (for example two stages). In a first embodiment, the conversion in step b) is effected in one stage. In this case, the lactam or aminocarbonitrile and any oligomers thereof are preferably reacted with water and optionally additives in a reactor.

Suitable reactors are the reactors which are known to those skilled in the art and are customary for preparation of polyamides. Preferably, the hydrolytic polymerization in step b) is effected in a polymerization tube or a bundle of polymerization tubes. Specifically, for the hydrolytic polymerization in step b), at least one VK tube is used. This German abbreviation “VK” stands for “vereinfacht kontinuierlich” [“simplified continuous”]. In a multistage version of the conversion in step b), preferably at least one of the stages is effected in a VK tube. In a two-stage version of the conversion in step b), the second stage is preferably effected in a VK tube. In a two-stage version of the conversion in step b), the first stage can be effected in a preliminary pressure reactor. In the case of use of an aminocarbonitrile, the conversion in step b) is generally effected in two or more stages, the first stage preferably being effected in a preliminary pressure reactor.

In a suitable embodiment, polyamide-6 is prepared in a multistage process, specifically a two-stage process. Caprolactam, water and optionally at least one additive, for example a chain transfer agent, are supplied to the first stage and converted to a polymer composition. This polymer composition can be transferred into the second stage under pressure or by means of a melt discharge pump. This is preferably effected by means of a melt distributor.

The hydrolytic polymerization in step b) is preferably effected at a temperature in the range from 240 to 280° C. In a multistage version of the hydrolytic polymerization in step b), the individual stages can be effected at the same or at different temperatures and pressures. In the case of performance of a polymerization stage in a tubular reactor, specifically a VK tube, the reactor may have essentially the same temperature over the entire length. Another possibility is a temperature gradient in the region of at least part of the tubular reactor. Another possibility is the performance of the hydrolytic polymerization in a tubular reactor having two or more than two reaction zones which are operated at different temperature and/or at different pressure. The person skilled in the art can select the optimal conditions as required, for example taking account of the equilibrium conditions.

When the hydrolytic polymerization in step b) is effected in one stage, the absolute pressure in the polymerization reactor is preferably within a range from about 1 to 10 bar, more preferably from 1.01 bar to 2 bar. Particular preference is given to performing the one-stage polymerization at ambient pressure.

In a preferred version, the hydrolytic polymerization in step b) is performed in two stages. The upstream connection of a pressure stage makes it possible to achieve a process acceleration, by performing the rate-determining cleavage of the lactam, specifically of caprolactam, under elevated pressure under otherwise similar conditions to those in the second reaction stage. The second stage is then preferably effected in a VK tube as described above. The absolute pressure in the first stage is preferably within a range from about 1.5 to 70 bar, more preferably within a range from 2 to 30 bar. The absolute pressure in the second stage is preferably within a range from about 0.1 to 10 bar, more preferably from 0.5 bar up to 5 bar. More particularly, the pressure in the second stage is ambient pressure.

Step c)

In step c) of the process according to the invention, the polyamide obtained in step b) is subjected to shaping to obtain polyamide particles.

Preferably, the polyamide obtained in step b) is first shaped to one or more strands. For this purpose, apparatuses known to those skilled in the art can be used. Suitable apparatuses are, for example, perforated plates, nozzles or die plates. Preferably, the reaction product obtained in step b) is shaped to strands in the free-flowing state and subjected in the form of strands of free-flowing reaction product to a comminution to give polyamide particles. The hole diameter is preferably within a range from 0.5 mm to 20 mm, more preferably 1 mm to 5 mm, most preferably 1.5 to 3 mm.

Preferably, the shaping in step c) comprises a pelletization. For pelletization, the polyamide obtained in step b), having been shaped to one or more strands, can be solidified and then pelletized. For example, Kunststoffhandbuch, 3/4 Technische Thermoplaste: Polyamide, Carl Hanser Verlag, 1998, Munich, p. 68-69 describes suitable measures. A specific shaping process is underwater pelletization, which is likewise known in principle to those skilled in the art.

Step d)

In step d) of the process according to the invention, the polyamide particles obtained in step c) are fed into a reaction zone for postpolymerization.

The polyamide particles obtained in step c) are preferably fed into a reaction zone for postpolymerization without being subjected to an extraction beforehand.

Preferably, the polyamide particles obtained in step c), for postpolymerization in step d), are subjected to a solid phase polymerization. This involves polymerizing the polyamide in the solid phase. The polyamide undergoes a heat treatment, the temperature being below the melting point of the polyamide.

Suitable reaction zones in which the postpolymerization takes place are in principle apparatuses as also usable for drying. These include customary driers, for example countercurrent driers, crosscurrent driers, pan driers, tumble driers, paddle driers, crossflow driers, cone driers; tower driers, fluidized beds, etc. Preference is given to using, as the reaction zone in which the postpolymerization takes place, at least one reactor, more preferably at least one tubular reactor. In a specific version, postpolymerization is accomplished using at least one tower drier. Preferably, a hot inert gas which is inert under the postpolymerization conditions flows through the tower drier. A preferred inert gas is nitrogen.

Suitable processes for postpolymerization of hydrolytically prepared polyamides are known in principle to those skilled in the art. The postpolymerization can be performed, for example, as described in WO 2009153340, EP 1235671 or EP 0732351.

The postpolymerization in step d) can be effected in one stage (in a single reaction zone). It can also be effected in more than one stage, for example in two stages, in a plurality of reaction zones which may be arranged in succession and/or in parallel. Preference is given to performing the postpolymerization in one stage.

In the postpolymerization, the temperature in the reaction zone is preferably within a range from 120 to 185° C., more preferably from 150 to 180° C.

In the postpolymerization, the pressure in the reaction zone is typically within a range from 1 mbar to 1.5 bar, more preferably from 500 mbar to 1.3 bar.

In the multistage postpolymerization, the polymerization apparatuses may be the same or different in terms of type and size. For example, it is possible to use two identical polymerization apparatuses, or two polymerization apparatuses of different sizes. For example, it is possible to operate two polymerization apparatuses in succession, in which case each has different residence time characteristics. For example, it is also possible to operate two polymerization apparatuses in succession, in which case each of the polymerization apparatuses has different pressure levels. For example, it is also possible to operate two polymerization apparatuses in succession, in which case different inert gas rates flow through each of the polymerization apparatuses. For example, it is also possible to operate two polymerization apparatuses in succession, in which case each of the polymerization apparatuses has different pressure levels and different inert gas rates flow through each of the polymerization apparatuses.

The temperature of the polyamide in the postpolymerization is typically controlled by means of heat exchangers, such as outer jackets, internal heat exchangers or other suitable apparatuses. In a preferred embodiment, the postpolymerization in step d) is effected in the presence of at least one inert gas. In that case, the temperature of the polyamide in the postpolymerization is controlled at least partly through the use of a hot inert gas. Preferably, during the postpolymerization, hot inert gas flows through the reaction zone. Suitable inert gases are, for example, nitrogen, CO₂, helium, neon and argon, and mixtures thereof. Preference is given to using nitrogen.

The residence time in the reaction zone in step d) is preferably 25 hours to 110 hours, more preferably 35 hours to 65 hours.

In a preferred embodiment, the residence time of the polymer in step d) is selected such that the relative viscosity of the polyamide increases by at least 10%, preferably by at least 15%, more preferably by at least 20%, based on the relative viscosity of the polyamide before step d).

The relative viscosity of the polyamide is typically used as a measure for the molecular weight. The relative viscosity is determined in accordance with the invention at 25° C. as a solution in 96 percent by weight H₂SO₄ having a concentration of 1.0 g of polyamide in 100 ml of sulfuric acid. The determination of relative viscosity follows DIN EN ISO 307.

Step e)

In step e), the polyamide particles obtained in step d) are subjected to an extraction.

Suitable processes and apparatuses for extraction of polyamide particles are known in principle to those skilled in the art.

Extraction means that the content of monomers and any dimers and further oligomers in the polyamide is reduced by treatment with an extractant. This can be accomplished industrially, for example, by continuous or batchwise extraction with hot water (DE 2501348 A, DE 2732328 A) or in a superheated water vapor stream (EP 0284968 W1).

Preference is given to extraction in step e) using an extractant comprising water or consisting of water. In a preferred version, the extractant consists solely of water. In a further preferred version, the extractant comprises water and a lactam used for preparation of the polyamide. In the case of polyamide-6, it is thus also possible to extract using caprolactam-containing water, as described in WO 99/26996 A2.

The temperature of the extractant is preferably within a range from 75 to 120° C.

Preferably, the temperature of the extractant during the treatment of the polyamide in step e) is in a range of from 50 to less than 120° C., preferably from 75 to 118° C., more preferably from 80 to 115° C. In a preferred embodiment, the extractant consists solely of water and the temperature of the extractant during the treatment of the polyamide in step e) is in a range of from 50 to less than 120° C., preferably from 75 to 118° C., more preferably from 80 to 115° C.

In a preferred embodiment, the polyamide is in the solid state during the treatment in step e).

In a further preferred embodiment, the extractant is in the liquid state during the treatment in step e).

The extraction can be effected continuously or batchwise. Preference is given to a continuous extraction.

In the extraction, the polyamide particles and the extractant can be conducted in cocurrent or in countercurrent. Preference is given to extraction in countercurrent.

In a first preferred embodiment, the polyamide particles are extracted continuously in countercurrent with water at a temperature of ≦100° C. and ambient pressure. In that case, the temperature is preferably within a range from 85 to 99.9° C.

In a further preferred embodiment, the polyamide particles are extracted continuously in countercurrent with water at a temperature of ≧100° C. and a pressure in the range from 1 to 2 bar absolute. In that case, the temperature is preferably within a range from 101 to 120° C.

For extraction, it is possible to use customary apparatuses known to those skilled in the art. In a specific version, extraction is accomplished using at least one pulsed extraction column.

For environmental and economical reasons, the extracted monomers and any dimers and/or higher oligomers are preferably recovered from the extractant and reutilized. The components present in the laden extractant obtained in step e), selected from monomers and any dimers and/or oligomers, can be isolated for this purpose and recycled into step a) or b).

A specific version of the process according to the invention comprises the following steps:
separating the laden extractant obtained in step e) into a fraction enriched in monomers and/or oligomers and a fraction depleted of monomers and/or oligomers,
feeding at least part of the fraction enriched in monomers and/or oligomers into the monomer composition provided in step a) or the reaction zone used for hydrolytic polymerization in step b),
reusing at least some of the fraction depleted of monomers and/or oligomers as the extractant in step e).

Step f)

Preferably, the extracted polyamide obtained in step e) is subjected to drying. The drying of polyamides is known in principle to those skilled in the art. For example, the extracted pellets can be dried by contacting with dry air or a dry inert gas or a mixture thereof. Preference is given to using an inert gas, e.g. nitrogen, for drying. The extracted pellets can also be dried by contacting with superheated water vapor or a mixture thereof with a different gas, preferably an inert gas. For drying, it is possible to use customary driers, for example countercurrent driers, crosscurrent driers, pan driers, tumble driers, paddle driers, crossflow driers, cone driers, tower driers, fluidized beds, etc. A suitable version is batchwise drying in a tumble drier or cone drier under reduced pressure. A further suitable version is continuous drying in tubular driers, through which a gas which is inert under the drying conditions flows. In a specific version, drying is accomplished using at least one tower drier. Preferably, a hot inert gas which is inert under the postpolymerization conditions flows through the tower drier. A preferred inert gas is nitrogen.

The process according to the invention can be performed continuously or batchwise, and is preferably performed continuously.

The process according to the invention leads to polyamides having particularly advantageous properties. A suitable measure for the polymer properties achieved is the viscosity number. The viscosity number (Staudinger function, referred to as VN or J) is defined as VN=1/c×(η−ηₛ)/ηₛ. The viscosity number is directly related to the mean molar mass of the polyamide and gives information about the processibility of a polymer. The viscosity number can be determined to EN ISO 307 with an Ubbelohde viscometer. The viscosity number of the polyamide obtained by the process according to the invention is preferably 185 to 260 ml/g.

Preferably, the polyamide obtained has a residual monomer content of less than 0.1% and preferably less than 0.055% by weight, more preferably less than 0.03% by weight. The cyclic dimer content is preferably less than 0.1% by weight, more preferably less than 0.05% by weight, especially less than 0.025% by weight, most preferably less than 0.01% by weight.

Preferably, the polyamide obtained has a residual lactam content of not more than 0.055% by weight and a residual cyclic dimer content of not more than 0.025% by weight.

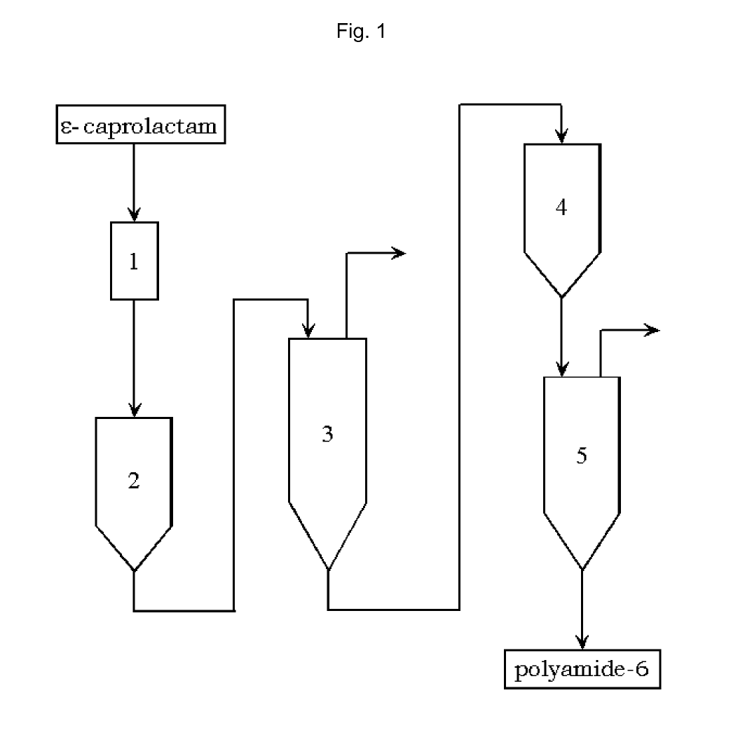

The process is illustrated in detail below by FIG. 1 and the examples.

FIG. 1 shows a schematic of one embodiment for performance of the process according to the invention.

In FIG. 1, the following reference symbols are used:
1 preliminary pressure reactor
2 VK tube
3 solid phase polymerization
4 extraction
5 drying

### EXAMPLES

### FIG. 1: Process According to the Invention for Preparation of Polyamide-6

### Examples 1-5

The starting material was a pelletized polyamide-6 intermediate available on the industrial scale, which was taken from a polyamide-6 production process after the pelletization which follows the one-stage melt polymerization in a VK tube. This intermediate had a viscosity of 139 ml/g, a caprolactam content of 12.84% and a dimer content of 0.37%.

For postpolymerization in the solid phase, 100 g of pellets were heat treated in a solid phase apparatus. The solid phase apparatus consisted of a glass tube with a frit base, which was heated by means of an outer jacket. The pellets were introduced into the preheated glass tube and hot nitrogen flowed through over a particular residence time. After the residence time, the pellets were removed and transferred to an extraction apparatus. The extraction apparatus used was a 2 l tank. This was done by first initially charging deionized water and heating it to 90° C. Addition of the pellets was followed by heating to the extraction temperature. The extraction was performed either batchwise or with constant exchange of the extractant. After a particular extraction time, the pellets were separated from the extractant by means of filtration using water-jet vacuum. The pellets obtained were dried at 120° C. by means of a hot nitrogen stream of 100 l/h dried.

Postpolymerization Conditions

| | Example | Example | Example | Example | Example |
|---|---|---|---|---|---|
| | 1 | 2 | 3 | 4 | 5 |
| Temperature [° C.] | 161 | 161 | 171 | 171 | 181 |
| Nitrogen flow rate [I/h] | 300 | 300 | 300 | 100 | 300 |
| Residence time [h] | 60 | 70 | 50 | 5 | 60 |

Extraction Conditions

| | Example | Example | Example | Example | Example |
|---|---|---|---|---|---|
| | 1 | 2 | 3 | 4 | 5 |
| Temperature [° C.] | 120 | 110 | 105 | 110 | 95 |
| Method of extraction | (A)* | (A)* | (B)* | (A)* | (A)* |
| Residence time of | 48 | 48 | 48 | 48 | 48 |
| pellets [h] | | | | | |
| Amount of pellets | 0.1 | 0.1 | 0.1 | 0.1 | 0.1 |
| [kg] | | | | | |
| Water flow rate | 0.3 kg/h | 0.3 kg/h | 0.3 kg | 0.1 kg/h | 0.1 kg/h |

*(A) = extractant in continuous flow, (B) = batchwise, extractant changed after 24 h

Analysis Values for Pellets after Performance of Postpolymerization, Extraction and Drying

| | Example | Example | Example | Example | Example |
|---|---|---|---|---|---|
| | 1 | 2 | 3 | 4 | 5 |
| Viscosity number | 180 | 190 | 188 | 195 | 206 |
| [ml/g] | | | | | |
| Caprolactam content | 0.04 | 0.03 | 0.02 | 0.01 | 0.01 |
| [%] | | | | | |
| Dimer content [%] | 0.02 | 0.04 | 0.04 | 0.01 | 0.03 |

1. A process for preparing a polyamide, comprising:
a) converting a monomer composition comprising a lactam or an aminocarbonitrile and/or an oligomer of these monomers in a hydrolytic polymerization at elevated temperature in the presence of water to obtain a reaction product comprising polyamide, water, one or more unconverted monomers and oligomers,
b) shaping the reaction product obtained in a) to obtain polyamide particles,
c) feeding the polyamide particles obtained in b) into a reaction zone for postpolymerization, and
d) treating the polyamide obtained in c) with at least one extractant, wherein the extractant is in the liquid state during the treating.

2. The process according to claim 1, further comprising drying the extracted polyamide obtained in d).

3. The process according to claim 1, wherein the monomer composition comprises ε-caprolactam or 6-aminocapronitrile and/or an oligomer of these monomers.

4. The process according to claim 1, wherein the conversion in a) is effected in one or more stages.

5. The process according to claim 1, wherein the conversion in a) is effected in two stages and an essentially vertical tubular reactor is used at least in the second stage.

6. The process according to claim 1, wherein the shaping in b) comprises a pelletization.

7. The process according to claim 1, wherein the polyamide particles obtained in b) are fed into the reaction zone for postpolymerization without being subjected to an extraction beforehand.

8. The process according to claim 1, wherein the polyamide particles obtained in b) are subjected to a solid phase polymerization for postpolymerization.

9. The process according to claim 8, wherein the reaction zone used for postpolymerization in c) comprises a tubular reactor or a tower drier.

10. The process according to claim 8, wherein the temperature during the postpolymerization in c) is within a range from 120 to 185° C.

11. The process according to claim 1, wherein the extractant employed in d) comprises water.

12. The process according to claim 1, wherein the temperature of the extractant during the treatment of the polyamide in d) is in a range of from 50 to less than 120° C.

13. The process according to claim 1, wherein the polyamide is in the solid state during the treatment in d).

14. The process according to claim 1, wherein the components present in the laden extractant obtained in d), selected from monomers and/or any dimers and/or oligomers, are isolated and recycled into a).

15. The process according to claim 1, wherein the process is performed continuously.

16. A polyamide obtained by the process of claim 1.

17. The polyamide according to claim 16, having a residual lactam content of not more than 0.055% by weight and a residual cyclic dimer content of not more than 0.05% by weight.

18. A pellet, film, fiber or molding comprising the polyamide according to claim 16.
